(19) United States
(12) Patent Application Publication
(10) Pub. No.: US 2024/0016676 A1
(43) Pub. Date: Jan. 18, 2024

(54) Wheelchair Wheel Turning Handle

(71) Applicant: Kevin Jackson, Suffield, CT (US)

(72) Inventor: Kevin Jackson, Suffield, CT (US)

(21) Appl. No.: 17/803,974

(22) Filed: Feb. 13, 2023

Related U.S. Application Data
(60) Provisional application No. 63/372,232, filed on Feb. 25, 2022.

(51) Int. Cl. A61G 5/02

(52) U.S. Cl. CPC A61G 5/022; A61G 5/025

(57) ABSTRACT

A wheelchair with two handles on each side that controls the rotation of the wheels. The handles both have levers that are pulled to seize a firm hold of the wheel to allow the wheels to be operated with the firm grip of a handle instead of circular handrails.

### FIELD

The present application relates to two handles which both extend at an upward slant from the wheels of a wheelchair and pushes the wheels forward and backwards when desired and automatically retracts to the back end of the wheelchair.

### BACKGROUND

The wheelchair is one of the most essential machines in the healthcare field as, they are vital for those who have limited to no ability to move their legs. These individuals must use a wheelchair for most transportation and if no, one can assist them by pushing their chair then they must roll themselves along manually, unless they have afforded themselves an electric wheelchair. These wheelchair users often become tired of the strenuous rolling back and forth whereby a dire need presents itself to alleviate this strain and discomfort.

### SUMMARY

The present application relates to a handle with a pulling bar which extends at an upward angle and slant on each side of the wheels of a wheelchair that moves back and forth and also drags the wheels forward or backwards whenever the user desires to. This gives the user an easier access and ability to move the wheels. The user would have a much firmer grip for pulling and pushing the wheels and would use less strength to operate the wheelchair.

Since the handles also retract back to there starting position the user does not need to pull them back which makes the handles easier to locate in the dark providing additional convenience.

On the handle, there is a bar that is pulled which causes the handle to seize a tight hold of the wheel whereby the user then also has control over the wheel to move it forward or backwards with the handle alone.

Accordingly the retractable wheelchair wheel handle is an efficiently designed and easy to use handle. It allows the user to do less bending to reach low for the wheel rails and it keeps them with a more sturdy posture lessoning strain on the spine.

Further objects, features, advantages and properties of the machine according to the present application will become apparent from the detailed description.

### BRIEF DESCRIPTION

In the following detailed portion of the present description, the teachings of the present application will be explained in more detail with references to the example embodiments shown in the drawings, in which:

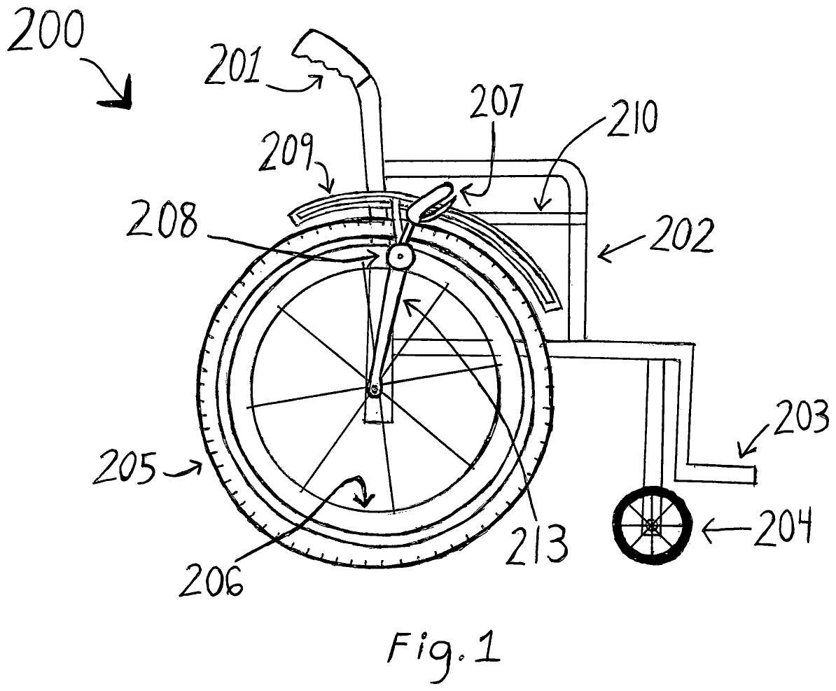

FIG. 1 is an isometric view of a wheelchair with a retractable wheel handle according to a first embodiment.

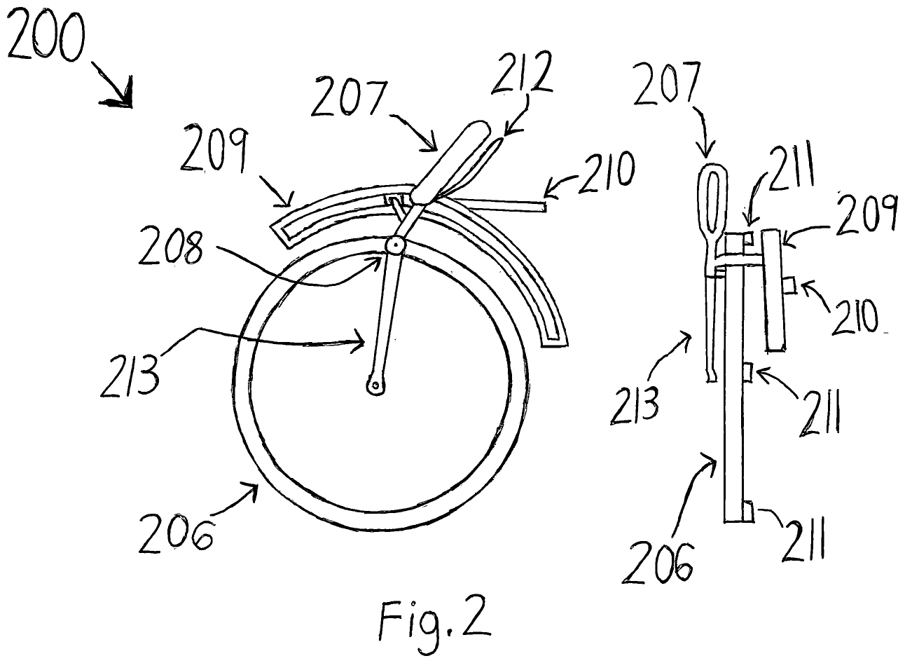

FIG. 2 is an isometric view of a retractable wheelchair wheel handle without a wheelchair according to a second embodiment.

### DETAILED DESCRIPTION

In the following detailed description, the device according to the teachings for this application in the form of a wheelchair with a wheel turning handle will be described by the embodiments. It should be noted that the machine is shown as an attachment to any common wheelchair but it can also be built into one.

A first embodiment of the wheelchair with the handle is illustrated in FIG. 1. The wheelchair 200 posses a top handle 201 which is what is held by a second person to push the wheelchair 200. The wheelchair 200 has front wheels 204 and back wheels 205, which are all basic features of a common wheelchair.

There is a circular ring 206 which clamps with screws onto the handrail section of the wheelchair 200. The circular ring 206 covers the circular handrail so the handrail cannot be seen. The handle 207 attaches to the circular ring 206 at its bottom 208. The handles bottom 208 spins around the circular ring 206 until the handles lever 212 is pulled which causes it to lock in place at its position on the circular ring 206 which is attached to the handrail of the wheelchair 200. The lever 212 on the handle 207 is positioned so the users fingers can pull it like the brakes on a bicycle.

When the lever 212 on the handle 207 is pulled, a wire inside of it pulls and causes the wheel 205 to be seized and controlled by the handle 207. The user can pull the lever 212 to move the wheel 205 forward or backwards, and release it to allow it to roll. The handles bottom 208 is connected to a rotating bar 213 which is connected to the center of the wheelchairs back wheel 205 and causes the handle 207 to stay in place.

There is a retraction box 209 which connects to the handle 207 and the wheelchair 200 with a small connector that can barely be seen which is a part of the handle 207 and extends into the retractor box 209. The retraction box 209 has a spring inside which always maintains an elastic force to keep the handle 207 held towards the back of the wheelchair 200 in its ideal position. A pole 210 is connected to the retraction box 209 that has a clamp with screws that simply attaches the retraction box 209 to the wheelchair 200.

A second embodiment of the wheelchair wheel handle with out the wheelchair is illustrated in FIG. 2. Each of the features of the machine are previously explained except for four clamps 211 on the circular ring 206 which clamp the circular ring 206 to the common wheelchairs circular handrail to hold it tightly in place. Each unit contains two handles with all of its components for each side of the wheelchair.

The teachings of the present application has numerous advantages. Different embodiments or implementations may yield one or more advantages. It should be noted that this is not an exhaustive list and there may be other advantages which are not described herein.

Although the teachings of the present application has been described in detail for the purpose of the illustration, it is understood that such detail is soley for that purpose and variations can be made by those skilled in the art without departing from the scope of the teachings of this application. It should be noted that the machine is described with a slanted handle but it can be made with a handle of any form such as to be as the handles of a bicycle with the handles right in from of the user or much higher then described. It should be noted that the wheelchair wheel turning handles can be made to rotate the wheels without the need to pull a lever on the handle.

Features described in the proceeding applications description may be used in combinations other then the combinations explicitly described.

Whilst endeavouring in the foregoing specification to draw attention to these features of the invention believed to be of particular importance it should be understood that the Applicant claims protection in respect of any patentable feature or combination of features hereinbefore referred to and/or shown in the drawings whether or not particular emphasis has been placed thereon.

The term “comprising” as used in the claims does not exclude other elements or steps. The term “a” or “an” as used in the claims does not exclude a plurality. A unit or other means may fulfill the functions of several units or means recited in the claims.

1. A pair of wheelchair wheel turning handles for the two sides of a wheelchair that is built into a wheelchair or can be an attachment to an existing wheelchair, each comprising: a circular ring which clamps onto the circular hand rail used to spin the wheelchairs wheels; a handle that connects to and spins around the said circular ring and has a lever that locks onto any position around the said circular ring to spin it whereby the wheelchairs wheel also spins with it since the wheelchairs circular hand rail controls its wheel and the said circular ring is bound to the wheelchairs circular hand rail; a bar with one end that connects onto the wheelchair wheels axle and connects its opposite end to the said handle to keep the handle steady and able to evenly circle around the said circular hand rail; and a retracting box that is clamped to the side of the wheelchair and is attached to the said handle and has an elastic spring inside of it that pulls handle to the back end of the wheelchair whenever there is no force applied to the said handle by the user.

2. A pair of wheelchair wheel turning handles according to claim 1, that can rotate the wheels of a wheelchair forward or backwards without the need to pull the said lever.
